(19) United States
(12) Patent Application Publication
(10) Pub. No.: US 2026/0315840 A1
(43) Pub. Date: Oct. 15, 2026

(54) ROOF-MOUNTED SPRINKLERS AND METHODS OF INSTALLATION THEREOF

(71) Applicant: Spot Fire Army LLC, Waterbury (CT)

(72) Inventor: Reuven VICKMAN, Waterbury, CT (US)

(21) Appl. No.: 19/637,496

(22) Filed: Apr. 2, 2026

Related U.S. Application Data
(60) Provisional application No. 63/785,708, filed on Apr. 9, 2025.

(51) Int. Cl. A62C 3/02

(52) U.S. Cl. CPC A62C 3/0214

(57) ABSTRACT

A roof-mounted sprinkler includes: a central pipe for receiving therein a flow of water, having at least one output nozzle at a top portion thereof; a plurality of legs, each leg being attached to the central pipe with a clamp that is convertible between a loose state, in which the clamp is rotatable around the pipe; and a tightened state, in which the clamp remains at a fixed angle relative to the pipe; and an anchor attached to each of the legs. A system includes the roof-mounted sprinkler, a hose arranged between a water source and the central pipe; a pump configured to draw water from the water source; and a roof-mounted hose holder including an elongated support, a central opening for receiving the hose therein; a plurality of legs attached to the elongated support with a clamp, and an anchor attached to each of the legs.

### RELATED APPLICATIONS

This Application claims the benefit of priority to U.S. Provisional Application No. 63/785,708, filed Apr. 9, 2025, entitled “Roof-Mounted Sprinklers and Methods of Installation Thereof,” the contents of which are hereby incorporated by reference as if fully set forth herein.

### TECHNOLOGICAL FIELD

The present disclosure relates to the field of fire protection, and more specifically, but not exclusively, to structures and methods for installation of roof-mounted sprinklers.

### BACKGROUND OF THE INVENTION

The advent of rapidly spreading forest fires has prompted a need for emergency firefighting, such as for residential homes or commercial structures. Often, municipal water supplies are overtaxed during a large forest fire. These circumstances are exacerbated by the increased development of homes in proximity to forests and less-developed areas.

One solution for firefighting without reliance on municipal water supplies is a roof-mounted sprinkler system. The roof-mounted sprinkler system is connected via a pump to a water reservoir, such as a well or a swimming pool. When a fire starts, the homeowner or business owner operates the sprinkler system. Wall-mounted sprinklers, which attach to the side of a building, are also known, but they are more limited in their ability to reach all surfaces of a roof.

One challenge with respect to roof-mounted sprinklers is designing the sprinkler in a manner that is easy and intuitive to install on a gable roof. A gable roof may be configured at various pitch angles. Thus, it is necessary to design the sprinklers with legs that may be configured at angles to match the pitch of the roof.

In addition to pitch angle of the legs, another challenge with respect to roof-mounted sprinklers is ensuring that the sprinkler is properly affixed to the roof. The sprinkler needs to be attached to the roof in a secure manner such that it will not topple over in the wind.

Various roof-mounted sprinklers have been developed in an attempt to address these challenges.

U.S. Pat. No. 6,360,968 to Orrange discloses a rooftop sprinkler with sprinkler legs comprising four low-weight plastic members that intersect in an “X” shape. Two sprinkler legs are placed on each of opposite roof slopes. The sprinkler legs may be anchored to the roof by means of sandbags or water containers. The '968 patent does not disclose any mechanism for adjusting the angle of the legs to match the pitch of the roof.

U.S. Pat. No. 7,673,696 to Gunn discloses a rooftop sprinkler with a base made of a loop of elongated rigid material, such as aluminum tubing, solid aluminum bar stock, or thin-walled steel tubing. The base has some weight which generates a low center of mass. The base may have feet formed of rubber hydrocarbon foam. The base also includes a bendable portion so that the loop can be caused to have a diverging angle between pairs of diagonal segments which match that of the pitch of the roof. The '696 patent does not disclose an attachment mechanism for attaching the legs to the roof. In addition, the construction of the base, including the bendable junction points, requires a custom-manufactured material that is not readily available to the standard consumer.

As the demand for rooftop sprinklers increases, it is becoming increasingly necessary to design a rooftop sprinkler with an attachment mechanism made of standard materials, which is adjustable to the pitch of the roof, and which is fixedly attachable (not just with gravity) to the roof itself.

### SUMMARY OF THE INVENTION

The present disclosure introduces a roof-mounted sprinkler with a novel attachment mechanism. This attachment mechanism is made of conventionally available parts; is adjustable according to a pitch angle of the roof; and is securely attachable to the roof beyond reliance on the weight of the legs. The attachment mechanism is easy to install and secure once placed into position. When combined with other parts of the rooftop sprinkler, the attachment mechanism ensures that the sprinkler remains on the roof and enables high-volume spraying of fluid onto the roof. Advantageously, the roof-mounted sprinkler described herein may be set up at one time, even years before a fire, may be operated remotely, and may run as needed so long as there is a power source and until a water source runs out.

According to a first embodiment, a roof-mounted sprinkler is disclosed. The roof-mounted sprinkler includes: a central pipe for receiving therein a flow of water, and having at least one output nozzle at a top portion thereof for spraying of the water; a plurality of legs, each leg being attached to the central pipe with a clamp that is convertible between a loose state, in which the clamp is rotatable around the pipe; and a tightened state, in which the clamp remains at a fixed angle relative to the central pipe; and an anchor attached to each of the legs.

The plurality of legs may include a single pair of legs arranged on opposite sides of the central pipe.

The legs may be arranged offset relative to the output nozzle, with one leg arranged in front of the nozzle and a second leg arranged behind the nozzle. In such embodiments, the anchors may be offset relative to a center of each leg and may be symmetrical relative to each other, such that the anchors balance a center of mass of the sprinkler.

In alternative embodiments, the plurality of legs comprise two or more pairs of legs arranged on opposite sides of the central pipe. In such embodiments, each anchor may be attached to all of the legs on a respective side of the central pipe.

The anchor may be a tube filled with one or more of sand, a fluid, or concrete.

A ridge cap tab may be arranged on an interior, roof-facing portion of each leg. In such embodiments, a vertical location of each ridge cap tab relative to each leg is adjustable. The ridge cap tab may be inserted underneath the ridge cap of the roof, to thereby fix the position of the legs on the roof.

A roof-mounted sprinkler system is also disclosed herein. The roof-mounted sprinkler system includes: the roof-mounted sprinkler; a hose arranged between a water source and the central pipe; a pump configured to draw water from the water source; and a roof-mounted hose holder, wherein the roof-mounted hose holder comprises: an elongated support; a central opening for receiving the hose therein, the central opening being arranged above the elongated support; a plurality of legs, each leg being attached to the elongated support with a clamp that is convertible between a loose state, in which the clamp is rotatable around the pipe, and a tightened state, in which the clamp remains at a fixed angle relative to the central pipe, and an anchor attached to each of the legs. A ridge cap tab arranged on an interior, roof-facing portion of each leg of the roof-mounted hose holder, wherein a vertical location of each ridge cap tab relative to each leg is adjustable. The sprinkler system may further include a remote-controlled solenoid valve for controlling flow of water from the water source to the hose, or from the hose to the nozzle.

In a second embodiment, a method of installing a roof-mounted sprinkler on a pitched roof having a ridge cap is disclosed. The roof-mounted sprinkler comprises a central pipe for receiving therein a flow of water, and has at least one output nozzle at a top portion thereof for spraying of water; a plurality of legs, each leg being attached to the central pipe with a clamp that is convertible between a loose state, in which the clamp is rotatable around the pipe; and a tightened state, in which the clamp remains at a fixed angle relative to the central pipe; and an anchor attached to each of the legs. The method includes: laying the sprinkler onto the ridge cap while the clamps are in a loose state, thereby allowing the clamps to rotate with respect to the central pipe so that an angle formed by opposing legs matches a pitch angle of the roof; and tightening the clamps, to thereby secure the roof-mounted sprinkler on the roof.

Optionally, the roof-mounted sprinkler further comprises a tab arranged on an interior, roof-facing portion of each leg, and the method further comprises: following the step of laying the sprinkler onto the ridge cap, raising the tabs relative to the legs so that a portion of each tab is underneath the ridge cap; and securing the tabs in place on each leg.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates components of a sprinkler system including a roof-mounted sprinkler, according to embodiments of the present disclosure;

FIG. 2 illustrates a first embodiment of a roof-mounted sprinkler, with four legs;

FIG. 3 illustrates a second embodiment of a roof-mounted sprinkler, with two legs;

FIG. 4 illustrates a roof-mounted hose holder;

FIG. 5 illustrates the roof-mounted sprinkler of FIG. 2 mounted on a roof and spraying water;

FIG. 6 illustrates the roof-mounted sprinkler of FIG. 3 mounted on a roof, with tabs inserted underneath the ridge cap;

FIG. 7 illustrates the hose holder of FIG. 4 mounted on a roof, with tabs inserted underneath the ridge cap;

FIGS. 8A-8C illustrate a sequence of installation of tabs underneath a ridge cap, according to some embodiments of the present disclosure;

FIG. 8D illustrates portions of the roof-mounted sprinkler separated from each other, enabling better understanding of the construction thereof; and

FIG. 9 illustrates an exemplary remote-controlled solenoid valve, according to embodiments of the present disclosure.

### DETAILED DESCRIPTION OF EMBODIMENTS

The present disclosure relates to the field of fire protection, and more specifically, but not exclusively, to structures and methods for installation of roof-mounted sprinklers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used in the present disclosure, water is used as the example of a fire-fighting fluid. The selection of water is based on its availability in close proximity to residential homes, such as in wells or swimming pools. However, water is not meant to exclude other firefighting fluids, or water mixed with firefighting chemicals, which may be stored or otherwise available to be pumped, in the manner disclosed herein.

The roof-mounted sprinklers disclosed herein are designed to provide consistent flow of water to a rooftop for purposes of fire fighting and fire prevention. One especially relevant function of the sprinkler is to keep the roof and perimeter of a house wet. As a result, when embers are driven by the wind onto the house, the wet roof and perimeter help prevent the embers from igniting the whole house. Studies show that 80-90 percent of houses that burn down in wind-driven fires catch fire from embers that land and ignite, as opposed to flames. Keeping the area wet lessens the chance of ignition.

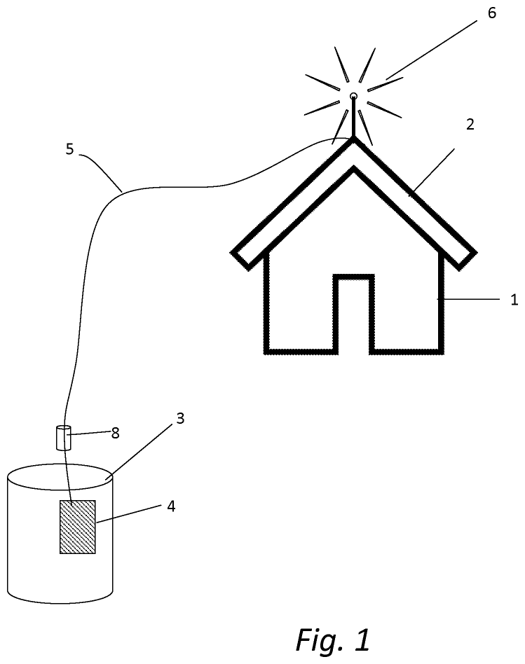

FIG. 1 schematically illustrates components of a roof-mounted sprinkler system, according to embodiments of the present disclosure. House 1 includes a gable roof 2. The house 1 is nearby a water source 3, which may be, for example, a well, a pond, or a swimming pool. Theoretically, the water source may also be a hose spigot connected to a municipal water supply, although such water sources may not be considered reliable in the event of a widespread fire, when demand is elevated. A pump 4 is inside or otherwise fluidically connected to the water source 3. Hose 5 runs from the water source 3 to a sprinkler 6 which is mounted on the roof 2 of the house.

The operation of the pump, and/or the flow of water through the hose, may be controlled by a remote-controlled solenoid valve 8, which may be operated via a Wi-Fi or cellular network, for example. In alternative embodiments, when the water supply is a well or pool that is not immediately dependent on the municipal water supply, the pump may be operated directly with a switch (such as a manual switch or a remote-controlled smart switch), without the use of a solenoid valve. The pump may be connected to a battery or other resilient power supply. During big fire events, the power grid is usually damaged, and in addition, often the power is intentionally shut off. In such circumstances, it is desirable to have an independent, non-electric power source, such as a gas-powered generator or a standby battery.

Although only one sprinkler is illustrated in FIG. 1, there may be multiple sprinklers arranged in series or in parallel. When there is more than one sprinkler, valves may be arranged therebetween so as to control which sprinklers receive water flow or emit fluid. In addition, there may be hose holders arranged on the roof in order to stabilize the hose on the roof. The hose holders may be arranged to support the hose 5 between the water source 3 and the nozzle 6, and/or to support additional hoses that connect between different nozzles on the roof 2.

In the illustrated embodiment, roof 2 is a gable roof. The term “gable roof,” as used in the present disclosure, refers to a roof consisting of two sections whose upper horizontal edges meet to form a ridge. The term “ridge” refers to the uppermost point of the roof. In a standard roof with a ridge, the ridge is covered with a ridge cap. A ridge cap is a special type of shingle which is thicker and pre-bent to allow the ridge cap to fit along the ridge easily. Typically, a ridge cap is installed with a small opening underneath, which permits air flow in and out of the attic, which is underneath the roof.

The systems and methods of the present disclosure are designed specifically for use on gable roofs. Gable roofs are common for residential homes, and also are often in close proximity to water sources that are near residential homes, such as swimming pools or wells. In addition, gable roofs, due to their pitch, pose a technical challenge of stabilizing the roof-mounted sprinkler. Thus, the systems and methods described herein are particularly relevant for gable roofs. However, the apparatuses described herein may also be applicable to any sort of roof on which it is desirable to install a roof-mounted sprinkler, especially one with a pitch angle.

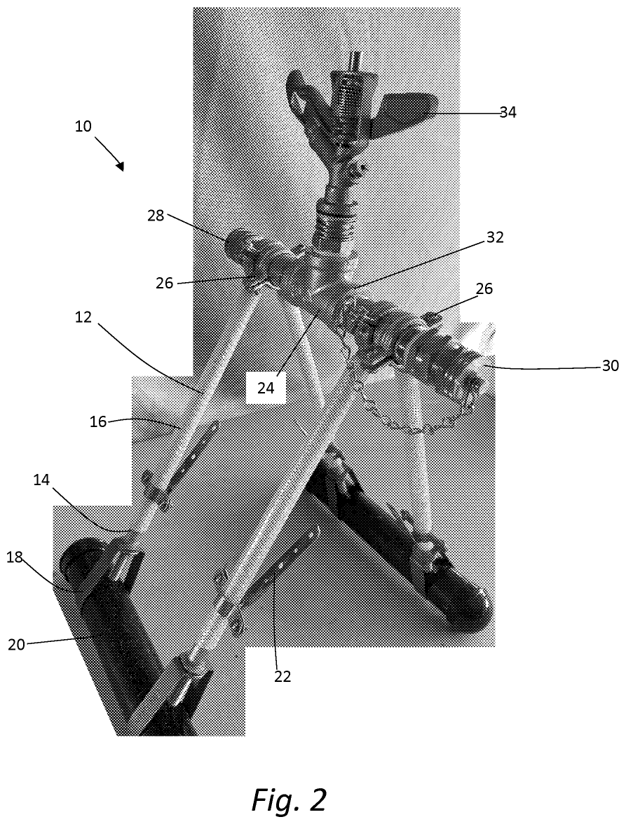

FIG. 2 illustrates a first embodiment of a roof-mounted sprinkler 10. The roof mounted sprinkler 10 includes two or more pairs of legs 12. The legs 12 are made of pipes 14, optionally with a rubber, silicon, vinyl or other polymeric sheath 16. The sheath 16 is made of a material which is UV-stable. One advantage of having a sheath 16 is to provide a surface around which the ridge cap tabs may be mounted tightly, as will be discussed further herein. The legs are arranged on opposite sides of a central pipe 24.

Each leg is attached to the central pipe 24 via clamp 26. Clamp 26 is convertible between a loose state, in which the clamp 26 is rotatable around the pipe; and a tightened state, in which the clamp 26 remains at a fixed angle relative to the central pipe. In the illustrated embodiment, clamp 26 is a split ring hanger. The split ring hanger, in the illustrated embodiment, is made of two half rings, in which one of the half-rings screws into or is bolted to the leg 12, while the other half-ring is fully detachable. The split ring hanger may be loosened or tightened around the central pipe 24 as desired. Advantageously, this setup allows for selection of an angle of the leg 12 with respect to the central pipe, i.e., by arranging the split ring hanger around the central pipe 24 in a loose manner, selecting the angle of the split ring hanger around the central pipe, and then tightening the bolts of the split ring hanger.

At the bottom of each of the legs 12, another pipe hanger 18 is arranged. In the illustrated embodiment, pipe hanger 18 is a band hanger. The band hanger is used to hold anchor tube 20. The band hanger is a useful type of pipe hanger for this purpose, insofar as the anchor tube 20 always remains at a fixed angle relative to the pipe hanger 18.

Anchor tube 20 is a small pipe with two endcaps. The tube may be hollow, with weight provided from the body of the tube 20. Alternatively, tube 20 may be filled with a filler material that provides additional weight. The filler material may be, for example, sand, concrete, or a fluid such as water. The anchor tubes 20 are, in the illustrated embodiment, elongated and attached to all of the legs 12 on each side. It is also possible, in principle, for each leg 12 to be attached to a separate anchor tube 20.

Ridge cap tabs 22 are arranged along legs 12. The ridge cap tabs 22 may be slid up and down along the legs 12, and then tightened over the sheath 16, such that a vertical location of each tab 22 relative to each leg 12 (i.e., the specific location on which the ridge cap tab 22 is mounted on the leg) is adjustable. The ridge cap tabs 22 may be secured in place using the screws on the ring holding the ridge cap tabs 22. Ridge cap tabs 22 are preferably made of a durable metal with some malleability, such as aluminum, brass, or copper. Advantageously, in such embodiments, the ridge cap tabs may be bent so that they may be precisely inserted under ridge cap shingles, as will be discussed further herein. In the illustrated embodiment, the ridge cap tab is made of a commercially available Milford pipe hanger, which has been shortened and bent to enable placement of the tab underneath the ridge cap. Advantageously, such materials are readily available and may be fit to the required dimensions of the roof-mounted sprinkler 10.

Central pipe 24 includes endcaps 28, 30. Endcap 28 is designed to be removed and attached to an input hose, which is connected to a water source, as discussed in connection with FIG. 1. Endcap 30 may be removed and connected to a different hose, in the event that it is desired to place multiple roof-mounted sprinklers in sequence, as discussed in connection with FIG. 1. Because the use of multiple roof-mounted sprinklers is optional, endcap 30 is fitted with a chain, so that it may be retained with the sprinkler 10 and replaced when desired.

Central pipe 24 further includes T-junction 32. The T-junction is connected to a sprinkler 34. Sprinkler 34 is used to spray water at up to 360 degrees radially around the axis of the central pipe 24.

The central pipe 24, sprinkler 34, and connections thereto may be made of any suitable material (e.g., steel, copper, cast iron, PVC, HDPE, ABS, etc.). These elements may also be made of any suitable dimensions, with the dimensions influencing the volume of water that may flow through pipe 24 and sprinkler 34. In exemplary embodiments, the pipe 24, sprinkler 34, and hoses connected thereto may have diameter of ½ inch, ¾ inch, or 1 inch.

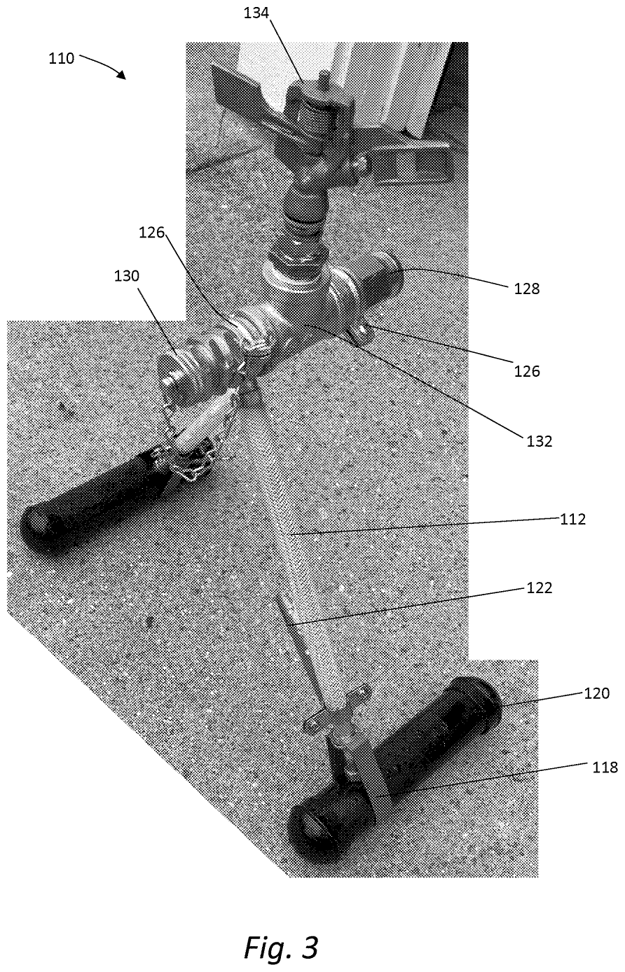

FIG. 3 illustrates a second embodiment of a roof-mounted sprinkler 110. Roof-mounted sprinkler 110 is similar in most respects to roof-mounted sprinkler 10, and thus similar reference numerals will be used to refer to similar components, except that the reference numerals begin with “1.” The main difference between the embodiment of FIG. 2 and the embodiment of FIG. 1 is that, in the embodiment of FIG. 2, there are only two legs 112 instead of four legs. A single pair of legs 112 is arranged on opposite sides of the central pipe 124. The legs are arranged offset relative to the output nozzle 134, with one leg 112 arranged in front of the nozzle 134 and one leg 112 arranged behind the nozzle 134 (where the terms “in front” and “behind” refer to the direction of the flow of water from the water source). Furthermore, in contrast to the embodiment of FIG. 2, in which the anchor tube is symmetrically configured between two legs, in this embodiment the anchor tube 120 is offset relative to the leg 112 to which it is attached. However, the two anchor tubes 120 are oriented symmetrically with respect to the central pipe 124. As a result, the anchor tubes 120 balance a center of mass of the sprinkler, and the sprinkler is able to rest properly on the pitched roof.

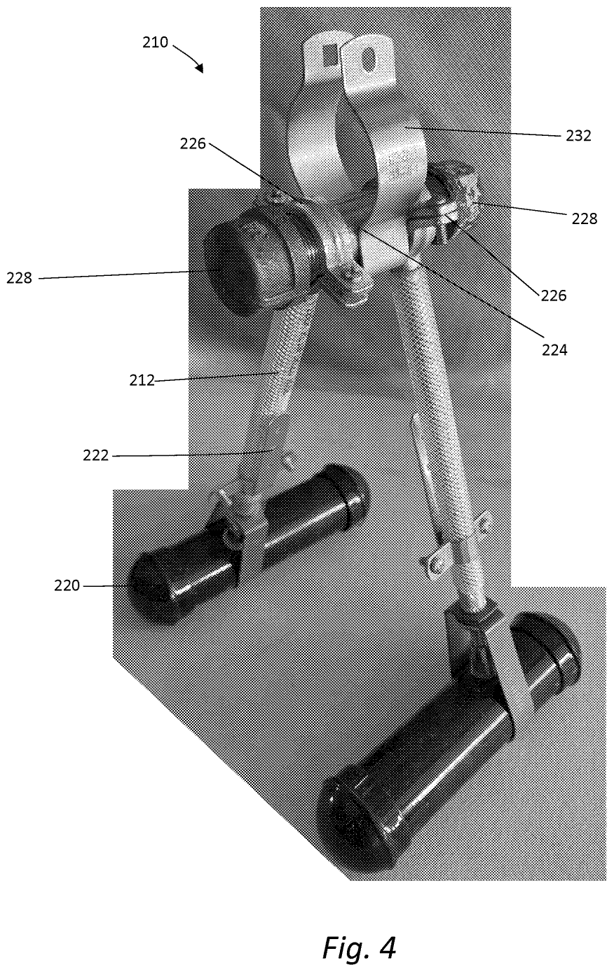

FIG. 4 depicts a roof-mounted hose holder 210. The roof-mounted hose holder 210 may be part of a sprinkler system that includes one or more of the roof-mounted sprinklers 10, 110, a hose arranged between the water source (as illustrated in FIG. 1), the water source, and the pump. The roof-mounted hose holder is similar in construction to embodiment 110 of the roof-mounted sprinkler, including the use of two legs 212 and the split ring pipe hanger or other clamp for adjusting an angle of each leg relative to the roof ridge, and the use of anchors attached to each of the legs. The main difference between the roof-mounted hose holder and the roof-mounted nozzle is that the legs of the roof-mounted hose holder are attached to an elongated support 224 which is solid, rather than a pipe. A pipe hanger 232 is attached to the elongated support 224 and includes, above the elongated support 224, a central opening through which a hose may be threaded. After the hose is threaded through the central opening, the top of the pipe hanger may optionally be screwed shut, to thereby ensure that the hose remains secure within the opening.

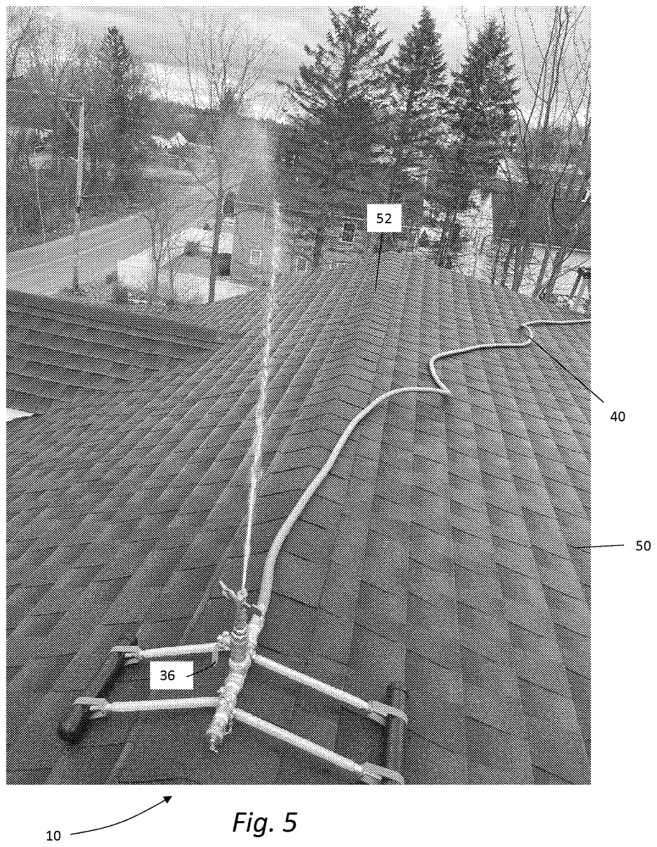

FIG. 5 illustrates the roof-mounted sprinkler 10 on a ridge cap 52 of roof 50. The hose 40 rests on the roof 50 and is connected to a water source (not shown). Water is pumped from the water source via the hose to the nozzle on the roof-mounted sprinkler 10. As can be seen, the legs of the roof-mounted sprinkler are set at angles that exactly match the pitch of the roof 50. Furthermore, the central pipe rests exactly on the ridge cap. Accordingly, the roof-mounted sprinkler is secure.

In the illustrated embodiment, the roof-mounted sprinkler 10 includes an optional valve 36 for direct control of on/off function of the nozzle. This may be useful if, for example, there are multiple sprinklers on the roof, and it is desired to direct flow to one or the other without removing any of the sprinklers.

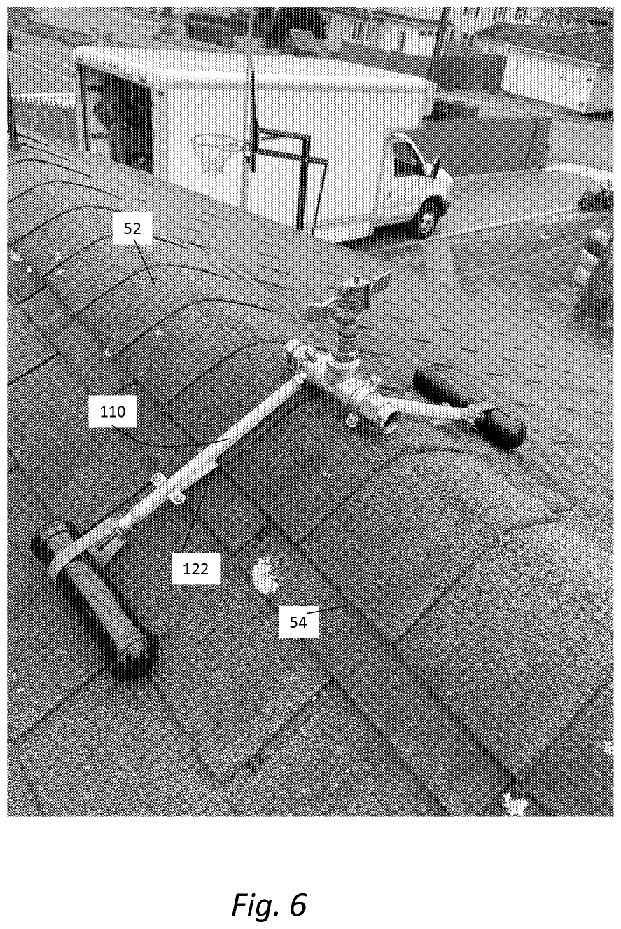

FIG. 6 illustrates the roof-mounted sprinkler 110 of FIG. 3 on the roof. As in FIG. 5, the central pipe rests on the ridge cap, and the legs are angled so as to match the pitch of the roof. In this view, the ridge cap tabs 122 are inserted in openings 54 underneath the ridge cap. The ridge cap tabs thus provide additional stability.

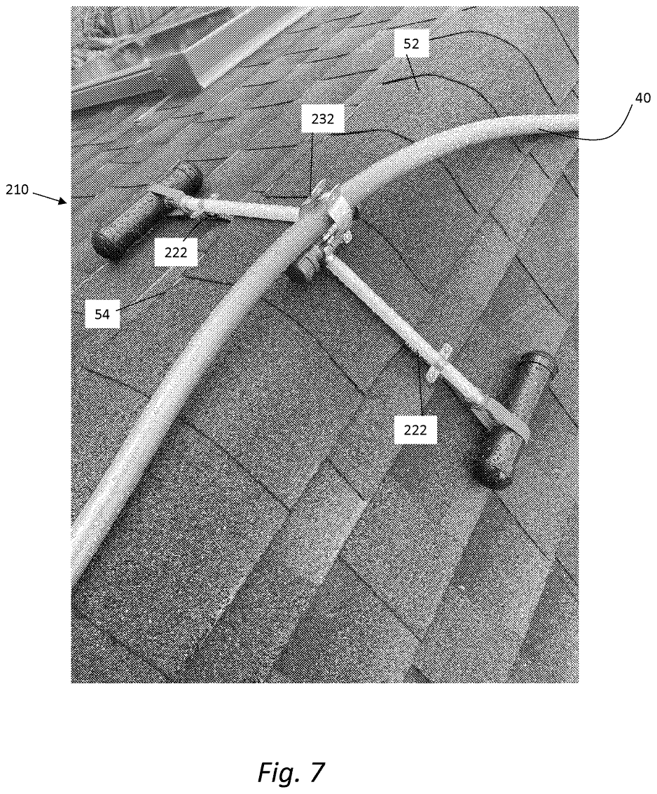

FIG. 7 illustrates the hose holder 210 on the ridge cap 52. A hose 40 is threaded through the hose holder. Similar to the roof-mounted sprinkler itself, the hose holder is seated directly on the ridge cap 52, with the legs matching the pitch angle of the roof, and with the ridge cap tabs 222 slotted within the openings 54 underneath the ridge cap.

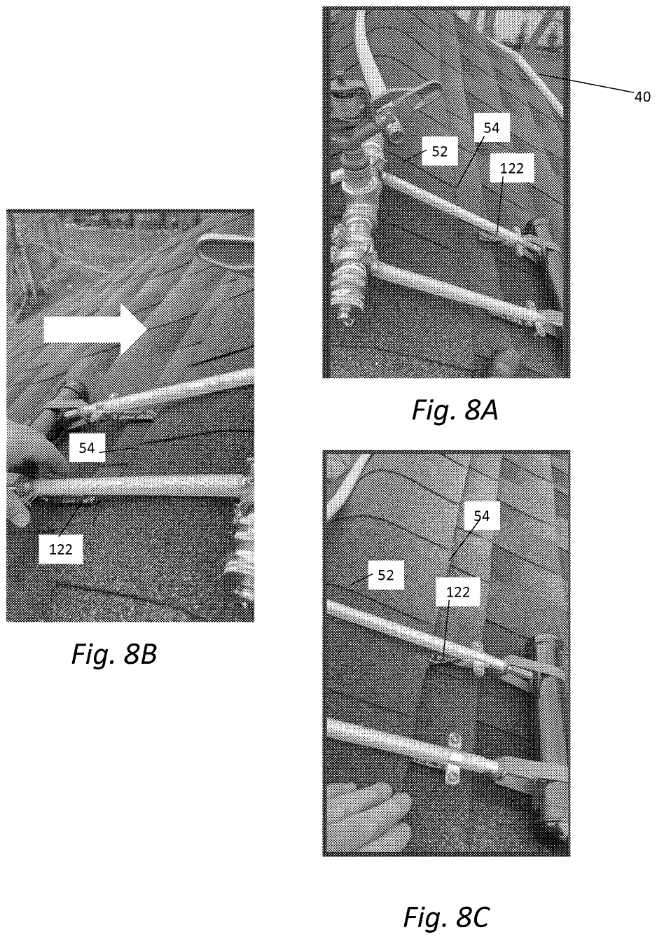

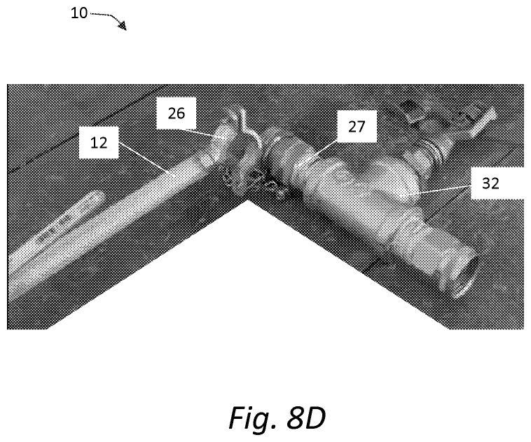

FIGS. 8A-8C depict steps in a method of installing the roof-mounted sprinklers and hose holders. At the view of FIG. 8A, the sprinkler is placed on the roof. The hose 40 is not yet connected at opening 28. In the first stage, the sprinkler is laid onto the ridge cap while the clamps are in a loose state. This allows the clamps to rotate with respect to the central pipe, so that an angle formed by opposing legs matches a pitch angle of the roof. When ridge cap tabs are present, at FIG. 8B, the user slides the ridge cap tabs 22 upwards into the openings under the ridge caps, so that a portion of each ridge cap tab is underneath the ridge cap. At FIG. 8C, the ridge cap tabs 22 are in place. The ridge cap tabs are secured in place, and the clamps are tightened. The sprinkler is now securely on the roof.

FIG. 8D illustrates leg 12 of the roof-mounted sprinkler separated from the central pipe, enabling understanding of the connection thereof. As can be seen, the clamp 26 is attached to leg 12 but not fitted around the central pipe. The central pipe includes narrower connection portions 27 on either side of the T-junction 32. These connection portions are slightly wider than the clamps 26. When the clamps 26 are placed around the connection portions 27, the combined diameter of the clamps 26 and the connection portions 27 is approximately the same as the diameter of the T-junction portion and the endcaps 28, 30. Furthermore, as discussed in connection with FIGS. 8A-8C, the angle of the leg 12 with respect to the central pipe may be varied, as desired, to match the pitch of the roof. As a result, the roof-mounted sprinkler 12 is able to lay stably on the ridge cap.

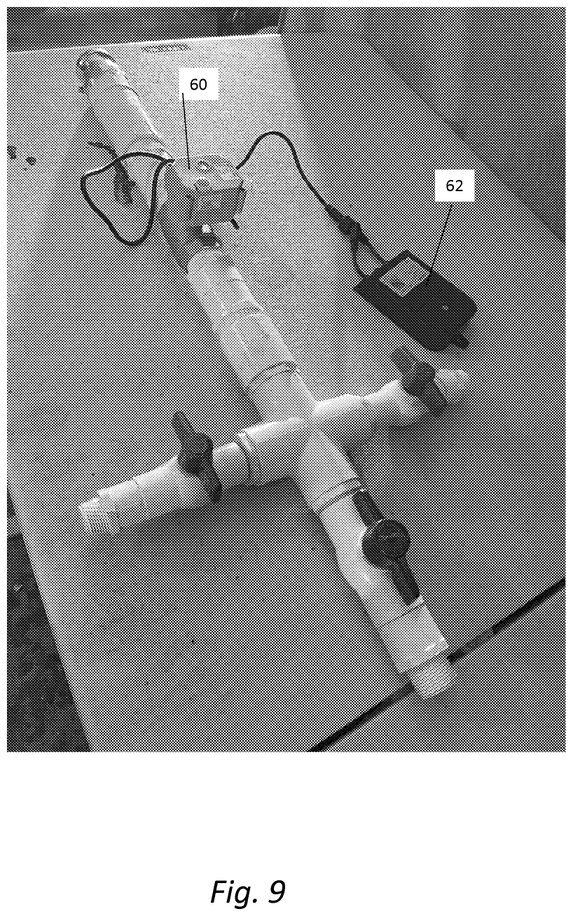

Referring to FIG. 9, as discussed, the sprinkler operation may be controlled remotely by a user, such as a homeowner. FIG. 9 illustrates a solenoid valve 60 which is controlled by controller 62. Controller 62 is configured to receive commands remotely, such as via Wi-Fi or via a cellular connection. In alternative embodiments, when the water supply is a well or pool that is not immediately dependent on the municipal water supply, the pump may be operated directly with a switch (such as a manual switch or a remote-controlled smart switch), without the use of a solenoid valve.

1. A roof-mounted sprinkler, comprising:
a central pipe for receiving therein a flow of water, and having at least one output nozzle at a top portion thereof for spraying of the water;
a plurality of legs, each leg being attached to the central pipe with a clamp that is convertible between a loose state, in which the clamp is rotatable around the central pipe;
and a tightened state, in which the clamp remains at a fixed angle relative to the central pipe; and
an anchor attached to each of the legs.

2. The roof-mounted sprinkler of claim 1, wherein the plurality of legs comprises a single pair of legs arranged on opposite sides of the central pipe.

3. The roof-mounted sprinkler of claim 2, wherein the legs are arranged offset relative to the output nozzle, with one leg arranged in front of the nozzle and a second leg arranged behind the nozzle.

4. The roof-mounted sprinkler of claim 3, wherein the anchors are offset relative to a center of each leg and are symmetrical relative to each other, such that the anchors balance a center of mass of the sprinkler.

5. The roof-mounted sprinkler of claim 1, wherein the plurality of legs comprise two or more pairs of legs arranged on opposite sides of the central pipe.

6. The roof-mounted sprinkler of claim 5, wherein each anchor is attached to all of the legs on a respective side of the central pipe.

7. The roof-mounted sprinkler of claim 1, wherein the anchor is a tube filled with one or more of sand, a fluid, or concrete.

8. The roof-mounted sprinkler of claim 1, further comprising a ridge cap tab arranged on an interior, roof-facing portion of each leg, wherein a vertical location of each ridge cap tab relative to each leg is adjustable.

9. A roof-mounted sprinkler system, comprising:
the roof-mounted sprinkler of claim 1;
a hose arranged between a water source and the central pipe; and
a pump configured to draw water from the water source; and
a roof-mounted hose holder, wherein the roof-mounted hose holder comprises:
an elongated support,
a central opening for receiving the hose therein, the central opening being arranged above the elongated support;
a plurality of legs, each leg being attached to the elongated support with a clamp that is convertible between a loose state, in which the clamp is rotatable around the pipe, and a tightened state, in which the clamp remains at a fixed angle relative to the central pipe, and an anchor attached to each of the legs.

10. The roof-mounted sprinkler system of claim 9, further comprising a ridge cap tab arranged on an interior, roof-facing portion of each leg of the roof-mounted hose holder, wherein a vertical location of each tab relative to each leg is adjustable.

11. The roof-mounted sprinkler system of claim 9, further comprising a remote-controlled solenoid valve or switch for controlling flow of water from the water source to the hose.

12. A method of installing a roof-mounted sprinkler on a pitched roof having a ridge cap, wherein the roof-mounted sprinkler comprises a central pipe for receiving therein a flow of water, and having at least one output nozzle at a top portion thereof for spraying of water; a plurality of legs, each leg being attached to the central pipe with a clamp that is convertible between a loose state, in which the clamp is rotatable around the pipe; and a tightened state, in which the clamp remains at a fixed angle relative to the central pipe; and an anchor attached to each of the legs, the method comprising:
laying the sprinkler onto the ridge cap while the clamps are in a loose state, thereby allowing the clamps to rotate with respect to the central pipe so that an angle formed by opposing legs matches a pitch angle of the roof; and
tightening the clamps, to thereby secure the roof-mounted sprinkler on the roof.

13. The method of claim 12, wherein the roof-mounted sprinkler further comprises a tab arranged on an interior, roof-facing portion of each leg, and wherein the method further comprises:
following the step of laying the sprinkler onto the ridge cap, raising the tabs relative to the legs so that a portion of each ridge cap tab is underneath the ridge cap; and securing the ridge cap tabs in place on each leg.
